(19) United States
(12) Patent Application Publication
(10) Pub. No.: US 2024/0180122 A1
(43) Pub. Date: Jun. 6, 2024

(54) AUTOMATED DEVICE FOR CONTROLLED FEEDING OF SUBSTANCES TO ANIMAL CONTAINMENT RECIPIENTS, RELATED SYSTEM AND METHOD

(71) Applicants: FUNDAÇÂO D. ANNA DE SOMMER CHAMPALIMAUD E DR. CARLOS MONTEZ CHAMPALIMAUD - CENTRO DE INVESTIGAÇÃO DA, Lisboa (PT); IDMIND - ENGENHARIA DE SISTEMAS, LDA, Lisboa (PT)

(72) Inventors: Almor Ricardo RIBEIRO DE SOUSA, Queluz (PT); Carios Alberto FERNANDES DA SILVA MARQUES, Carnaxide (PT); Joana GASPAR LOPES, Carvoeria MFR (PT); Paul Jorge GONÇALVES ALVITO, Moscavide, Lissboa (PT); Ana Catarina Caetano Certal Afonso, Lisboa (PT); Joana FREIRE DE CASTIÇO MONTEIRO, Paço De Arcos (PT)

(21) Appl. No.: 18/285,908

(22) PCT Filed: Apr. 5, 2022
(86) PCT No.: PCT/PT2022/050015

§ 371 Date: Oct. 6, 2023

(30) Foreign Application Priority Data
Apr. 6, 2021 (PT) 117161

(51) Int. Cl. A01K 5/02; A01K 61/85

(52) U.S. Cl. CPC A01K 5/02; A01K 61/85

(57) ABSTRACT

Automated device for the controlled feeding of substances to animal containment recipients in an animal breeding facility, including at least one rack for such animal containment recipients, said racks being arranged in lines (1) comprising a plurality of animal containment recipients (2), in which said recipients are arranged in the form of a grid on the rack (1); wherein the device includes a robot (3) with a locomotion platform, a lifting mechanism, a feeding platform, a feeding circuit and a central processing unit, and travels on a horizontal, linear track (9) having a reflective strip (10). The automated device solves the problems of the prior art, as it travels between various lines of racks (1), preventing the need for installing individual systems for each rack (1), having high precision in terms of Cartesian coordinates when feeding the animals in the recipients (2), and including laser scanning sensors (30) and optical sensors for following a reflective strip (32).

### TECHNICAL DOMAIN

The present invention refers to an automated device, a system and method for the controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack.

### PRIOR ART

Many laboratories and investigation centers use installations for the breeding and reproduction of animals, viewing the obtainment of specimens for experimental procedures to be conducted. From among the installations for the breeding and reproduction of animals most typically used, we can reference those related to the breeding of fish, which may have various racks for animal containment recipients (rack) usually comprising 10 to 20 animal containment recipients per rack, namely tanks or aquariums. A plurality of racks is also frequently used for animal containment recipients, disposed in rows, wherein the total number of containment recipients may be higher than 2500 tanks.

Therefore, the animals can be fed manually, which may require a high outlay of human resources, since the professionals in charge of feeding the animals contained in the containment recipients have to carry out various tasks related with the feeding, several times per day, including the administration of different types of nutrients or foods, and said tasks would also have to be carried out at weekends and on holidays.

The state of the art also presents automated systems for feeding animals in said breeding installations, though these systems are dedicated to just a few racks for animal containment recipients. Therefore, when the animal breeding installation presents various rows of racks, there is a need to install an automated system for each one of the rows, which will certainly trigger a significant increase in operating and maintenance costs for the various automated systems which would be required. The increase in costs may be exacerbated in cases wherein the animal breeding installations operate below their nominal capacity, which may result in the status that a certain automated system of a given rack is not being used, that is, is idle.

### SUMMARY OF THE INVENTION

The present invention refers, in a first aspect, to an automated device for the controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, comprising:
a robot (3), which comprises a locomotion platform (4); a hoist mechanism (5); a feeding platform (6);
a feeding circuit (7); and a central processing unit (8);
   wherein the robot (3) is configured to transit on at least one horizontal, linear track (9), which is disposed parallel to each rack for animal containment recipients disposed in a row (1), wherein a reflective strip (10) is disposed next to a terminal position of said horizontal, linear track (9);
   wherein the locomotion platform (4) comprises at least one drive wheel (11); a first motorization unit (12) and a sensorial navigation unit (13); the sensorial navigation unit (13) being configured to locate and navigate the platform in the work space and to detect the reflective strip (10) and the first motorization unit (12) configured to move the locomotion platform (4) along the horizontal, linear track (9);
   wherein the hoist mechanism (5) comprises a hoist axis (14), which is perpendicular to the horizontal, linear track (9); and a second motorization unit (16), which is configured to move the feeding platform (6) along the hoist axis (14); and the hoist mechanism (5) is connected to the locomotion platform (4);
   wherein the feeding platform (6) comprises a rack (17), which is connected to a feed head (43); a sensorial feeding unit (18), which is configured to send data to the central processing unit (8) on the position of the feed head (43) in relation to the feeding zone of the animal containment recipient (2); a second processing unit (19); a third motorization unit (20), which is configured to move the rack (17) along a horizontal axis, which is perpendicular to the hoist axis (14), for the feed head (43) to reach the substance feeding zone in an animal containment recipient (2);
   wherein the feeding circuit (7) comprises one or more feeding circuits selected from the group consisting of a dry feeding circuit (21) and a circuit of liquid feeding circuit (22);
   wherein the central processing unit (8) receives data on position, orientation and speed relating to the locomotion platform (4), said data being collected by the sensorial navigation unit (13) and processed by the central processing unit (8);
   wherein the central processing unit (8) receives data on feeding parameters for each animal containment recipient (2), said data being collected by the sensorial feeding unit (18) and processed by the second processing unit (19);
   wherein the central processing unit (8) controls the movement of the locomotion platform (4) along at least one horizontal, linear track (9) and along at least one passage adjacent to a horizontal, linear track (9), the movement of the feeding platform (6) along the hoist axis (14) and the feeding of the animal containment recipient (2) by the feed head (43).

The present invention refers, in a second aspect, to an automated system for the controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, comprising:
an automated device for the controlled feeding of substances to animal containment recipients in an animal breeding installation, according to the first aspect of the invention; and
at least one horizontal, linear track (9), which is disposed on the ground and parallel to each rack for animal containment recipients disposed in a row (1), wherein a reflective strip (10) is disposed next to a terminal position of said horizontal, linear track (9).

The present invention refers, in a third aspect, to a method of controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, comprising the following steps:
i. an automated device, according to the first aspect of the invention, transiting alongside at least one rack for animal containment recipients disposed in a row (1);
ii. said automated device detecting a horizontal, linear track (9), which is disposed on the ground and parallel to each rack for animal containment recipients disposed in a row (1);
iii. said automated device moving along the horizontal, linear track (9) by means of a locomotion platform (4), comprised in said automated device, in order to position itself opposite the axis perpendicular to the ground, which passes by a certain animal containment recipient (2);
iv. a hoist mechanism (5) of said automated device adjusting the position of a feeding platform (6) along said axis perpendicular to the ground, which passes by a certain animal containment recipient (2), in order to position the feeding platform (6) at the height of a certain animal containment recipient (2);
v. A feeding platform (6) adjusting the position of a rack (17) along a plane parallel to the ground, in order for a feed head (43) to reach a substance feeding zone in a certain animal containment recipient (2);
vi. The automated device repeating the preceding steps until food is supplied to a predetermined set of animal containment recipients (2) disposed on the rack (1).

### Problems of Prior Art

North-American patent U.S. Pat. No. 8,499,719B2, by Marco Brocca and Giovanni Frangelli and published on Aug. 6, 2013, refers to a robotic system for feeding and breeding fish, namely zebra fish destined for laboratory tests and bred in racks with a plurality of tanks, and the food dosage system can move along a system of Cartesian axes.

The Chinese patent application CN105684979A, by Zhang Qiong and published on Jun. 22, 2016, refers to an automatic system for the feeding/breeding of zebra fish for experimental applications comprising a food dispenser, which is configured for dispensing foods to a tank with fish, wherein the food dispenser has a vertical movement along a vertical track. Additionally, there is a device that confers horizontal movement along a track horizontal.

The international patent application WO2009072982A1, by Lau Lionel et al. and published on Jun. 11, 2009, also refers to an automated system for feeding fish, namely zebra fish for experiment purposes, present in a plurality of tanks, disposed in rows and columns. The food dosing system disclosed in WO2009072982A1 comprises a plurality of syringes, wherein each one of the syringes provides the food paste to the breeding tanks. The food dosing system comprises vertical and horizontal tracks and engagement means for transporting syringes to each one of the tanks. Additionally, a programmable logic controller controls the movement of the syringe along the horizontal and vertical axes.

In this sense, said documents of the state of the art indicate that the food dosing system should be connected and dedicated to each row of racks (1) containing animal containment recipients (2).

### Solving the Problem

The automated system for the controlled feeding of substances to animal containment recipients in an animal breeding installation of the present invention solves the problems of the state of the art, since the system is capable of feeding animals present in containment recipients disposed in various rows of racks for animal containment recipients. The solution comprises characteristics of an automated system that includes a robot (3) with capacity for transiting between various rows of racks (1) and which has a high degree of accuracy, in terms of the three Cartesian space coordinates, to feed the animals contained in the various animal containment recipients (2).

In order to install the robot (3) in a new animal breeding installation or in a pre-existing installation, the installation of a horizontal, linear track (9) is required, positioned before each one of the racks (1), preferably parallel to the racks (1).

### Advantageous Effects of the Invention

The substantial difference of the device and of the system of the present invention in relation to the systems disclosed in U.S. Pat. No. 8,499,719B2, in CN105684979A, in CN205409160U, in WO2009072982A1 and in CN206150194U refers to the use of a system of linear tracks (9) and of a locomotion platform (4) with positioning identification sensors, which enables navigation along various rows of racks (1) containing recipients (2), namely tanks with fish by means of identifying a linear track and by means of sensors, such row detection sensors and laser sensors. In a unique way, the system of the present invention is disconnected from the rack (1) with animal containment recipients (2). In fact, the unique system according to the present invention enables various rows of racks (1) to be covered, whereas the documents from the state of the art require the installation of an automatic feeding system for each one of the rows of racks (1).

The robot (3) is autonomous and comprises various sets of sensors, actuators and processing units that enable the supply of precise, automated feeding for a plurality of animal containment recipients, disposed in various rows of racks for animal containment recipients (1). The robot (3) may comprise at least one battery which gives it heightened operating autonomy and may also be capable of communicating with external infrastructures, in order to send and receive data related to the feeding activities of the animals bred in the animal breeding installation.

### BRIEF DESCRIPTION OF THE DRAWINGS

With the aim of promoting an understanding of the principles according to the embodiments of the present invention, reference will be drawn to the embodiments illustrated in figures and to the language used to describe them. In any case, it should be understood that there is no intention of limiting the ambit of the present invention to the content of the drawings. Any subsequent alterations or modifications of the inventive characteristics illustrated herein, as well as any additional applications of the principles and embodiments of the invention illustrated, which would normally occur for a person skilled in the art being in possession of this specification, are considered within the ambit of the invention claimed.

FIG. 1—Perspective representation of an embodiment of the automated system according to the present invention;

FIG. 2—illustrates a processing system of a robot according to the invention;

FIG. 3—illustrates a set of sensors of a robot according to the invention;

FIG. 4—illustrates a perspective view of a robot according to the invention;

FIG. 5—illustrates a side view of the main components of the automated device according to the invention;

FIG. 6—illustrates a perspective view of a locomotion platform;

FIG. 7—illustrates a cutaway top view of a locomotion platform;

FIG. 8—illustrates another perspective view of a locomotion platform;

FIG. 9—illustrates a bottom view of a locomotion platform;

FIG. 10—illustrates a perspective view of the alignment of the robot with a horizontal, linear track;

FIG. 11—illustrates a top view of the locomotion of the robot with a horizontal, linear track;

FIG. 12—illustrates a front view of the feeding platform being moved by the hoist mechanism;

FIG. 13—illustrates a perspective view of a feeding platform;

FIG. 14—illustrates a side view of a feed head in movement to align with a food entrance orifice in an animal containment recipient and in movement to a rest position;

FIG. 15—illustrates a side view of the dry feeding circuit;

FIG. 16—illustrates a schematic diagram of the dry feeding circuit;

FIG. 17—illustrates a schematic diagram of the liquid feeding circuit.

### DESCRIPTION OF THE EMBODIMENTS

As illustrated in FIG. 1, an automated system for the controlled feeding of substances to animal containment recipients in an animal breeding installation according to the present invention presents a robot (3), which has the capacity for transiting between various rows of racks for animal containment recipients (1), and each rack (1) has a plurality of animal containment recipients (2), disposed for example in a grid arrangement of rows and columns. The robot (3) moves along the different rows of racks (1) along a horizontal, linear track (9), which is disposed before each rack (1). In order to identify the horizontal, linear track (9) accurately, as the robot transits between the different rows of racks (1), various navigation sensors are installed on the robot, for example laser scanning sensors (30) and optical sensors for following the reflective strip (32), and a reflective strip (10) is disposed alongside the horizontal, linear track (9), in order for the sensorial navigation unit (13) of the robotic device to easily identify said horizontal, linear track (9).

Preferably, the robot (3) will operate on a flat ground or floor, wherein the mobility is performed by means of drive wheels (11). Therefore, the locomotion of the robot (3) may be non-holonomic, for example by means of two, four or six drive wheels (11). Alternatively, the locomotion of the robot (3) may be holonomic, for example using a set of omnidirectional wheels (11), only at ground level.

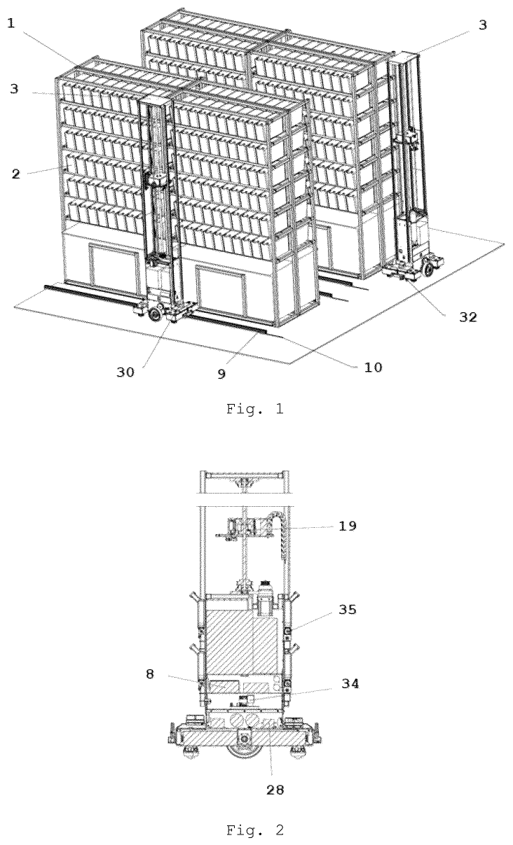

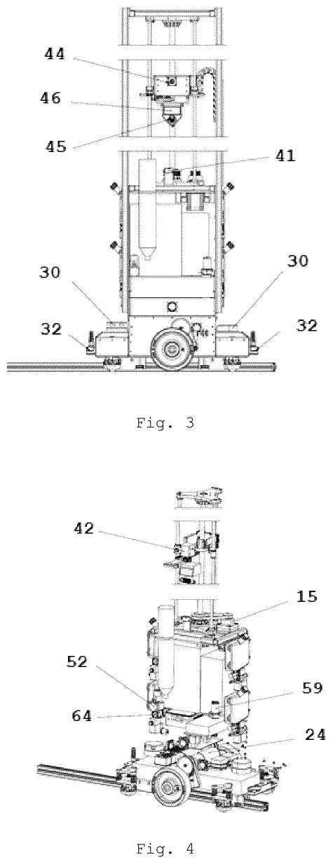

In the preferred embodiments of the invention, as illustrated in FIG. 2, the processing system of the robot (3) comprises a central processing unit (8), which can communicate with various controllers and processers. Illustratively, the central processing unit (8) can communicate with a motor command unit (28), in order to give it instructions to activate or deactivate the first motorization unit (12), disposed on the locomotion platform (4). The central processing unit (8) may also communicate with an energy management controller (34), in order to manage the energy available in the set of batteries of the robot (3). Additionally, the central processing unit (8) may also communicate with a controller of the feeding circuit (35) and with a controller of the feed head, whose elements respectively controlled will be detailed further ahead.

The robot (3) has a set of sensors that enable the precise fulfillment of their functionalities related to the automated feeding of the plurality of recipients (2) disposed on the various racks (1) in a row. As illustrated in FIG. 3, the locomotion platform (4) has a sensorial navigation unit (13), which presents a set of sensors, for example laser scanning sensors (30), incremental rotary encoder sensors (31), optical sensors for following reflective strip (32) and an inertial measurement unit (33), which enable the precise identification of the start of a horizontal, linear track (9), as well as the precise navigation alongside. Additionally, the feeding platform (6) has a digital image capture sensor (44), namely a digital camera, which can gather information related to the quantity and the type of animals in each one of the containment recipients (2). The feeding platform (6) also has a distance measurement sensor (45), which enables the precise approximation of the feed head (43) to the substance feeding zone in an animal containment recipient (2). The feeding platform (6) also has a bar code reading sensor (46), which can identify specific feeding parameters on a bar code label fixed on the containment recipients (2).

In other embodiment according to the the invention, the horizontal, linear track (9) can be part of the structure of a rack for animal containment recipients disposed in a row (1), being connected to the base of said rack (1) next to the ground and parallel to said rack (1).

As illustrated in FIG. 4, the locomotion platform (4) of the robot (3) has a first motorization unit, which includes a motor (24). In this embodiment, some elements that are part of the feeding circuit are connected to the locomotion platform (4), namely the compressed air compressor (52), which is used during the course of the transfer of dry foods to the recipients (2) with animals, and the first liquid circulation pump (59), which is used during the course of the transfer of liquid foods to the recipients (2) with animals. FIG. 4 also presents a step motor for dosing dry food (64); a motor of the hoist mechanism (15) and a motor of the feeding platform (42), the three latter being used to carry out fine adjustment movements of each one of the respective elements of the robot. In the preferred embodiments of the invention, the motor of the hoist mechanism (15) is a step motor.

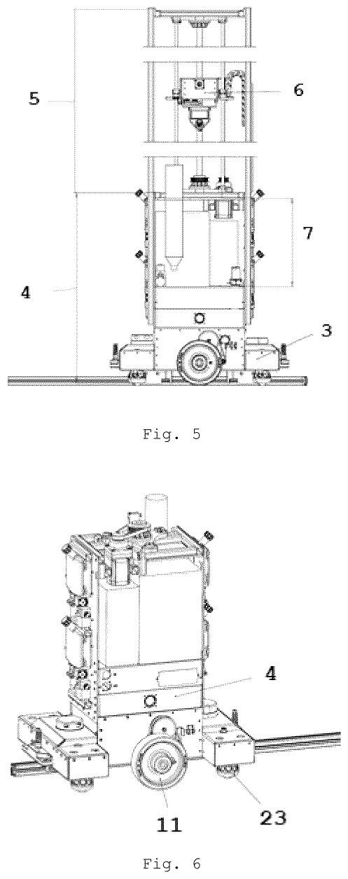

As illustrated in FIG. 5, the automated device for the controlled feeding of substances to animal containment recipients in an animal breeding installation includes a robot (3), that comprises a locomotion platform (4); a hoist mechanism (5); a feeding platform (6); and a feeding circuit (7). The locomotion platform (4) provides the control and the holonomic and non-holonomic movement of the robot and includes batteries, motors, motor command units, sensors. Preferably, the central processing unit (8) may be included in the locomotion platform (4). In the preferred embodiments, the feeding circuit is connected to the locomotion platform (4), and this also supports the hoist mechanism (5). The hoist mechanism (5) enables the feed head to be hoisted to a certain height, in order for a certain animal containment recipient (2) in the rack (1) to be achieved. The feeding platform (6) includes the sensors and actuators necessary to detect a substance feeding zone in an animal containment recipient (2), namely an orifice in said recipient (2), besides adjusting the position of the feed head (43) to the required position. The feeding circuit is configured to supply dry and/or liquid foods to a given recipient (2).

Subsequent subsections will set out further details on each one of the components of the automated device for the controlled feeding of substances to animal containment recipients in an animal breeding installation of the invention.

### Locomotion Platform

The locomotion of the automated device according to the invention is based on a robot (3) with drive wheels (11), especially configured to move on flat surfaces.

In the preferred embodiments of the invention, the locomotion platform (4) comprises at least two drive wheels (11) and at least four casters (23), two casters (23) being disposed in a front position in relation to said drive wheels (11) and two casters (23) disposed in a rear position in relation to said drive wheels (11).

As illustrated in FIG. 6, in one of the embodiments of the present invention, the locomotion platform (4) has two drive wheels (11) disposed in a central position on the base of the chassis of the locomotion platform (4) and four casters (23), such that the movement of said locomotion platform (4) is non-holonomic and uses the configuration with differential command. In this embodiment, two casters (23) are disposed in a front position of the locomotion platform (4) and two casters are disposed in a rear position of the locomotion platform (4). Each one of the casters (23) is preferably installed with springs, wherein this set helps the stabilization of the robot (3) during the course of its locomotion or in adapting to irregular floors, preventing the loss of contact of the drive wheels (11).

In one of the embodiments of the present invention, the first motorization unit (12) comprises at least one motor (24) and a gearbox (25), wherein the power is transferred to the drive wheels (11) by means of at least one pulley (26) and a transmission belt (27).

Preferably, the sensorial navigation unit (13) comprises one or more sensors selected from the group consisting of a laser scanning sensor (30), an incremental rotary encoder sensor (31), an optical sensor for following a reflective strip (32) and an inertial measurement unit (33), configured to collect data related with the position, the orientation and the speed of the locomotion platform (4).

In other embodiments of the invention, the horizontal, linear track (9) comprises a plurality of markers (36), disposed along the length of said linear track, which are selected from the group comprised of markers detectable by optical sensors or by magnetic sensors.

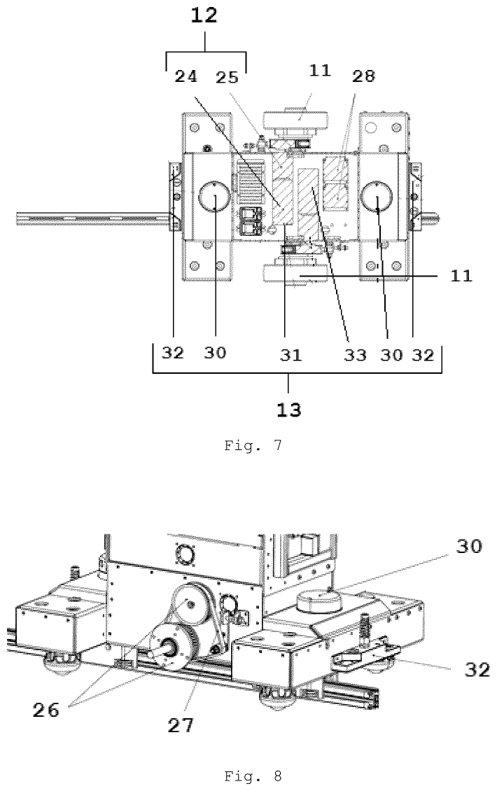

In one embodiment of the locomotion platform (4), as illustrated in FIGS. 7 and 8, the first motorization unit (12) comprises two motors (24), which are connected to a gearbox (25), which operates by gearings and incremental rotary encoder sensors (31). The transfer of driving force to the drive wheels (11) is carried out by means of at least one pair of pulleys (26) and a transmission belt (27). The central processing unit (8) sends speed and position commands to the motor command units (28) in order to actuate the motors (24).

The locomotion platform (2) charges batteries that provide energy to the motors and electric and electronic components of the robot (3). Preferably, the locomotion platform (2) also comprises the central processing unit (8), which receives the data collected by the various auxiliary processing units, motor command units (28) and sensors in order to calculate the route of locomotion, generate trajectories and speeds for each one of the drive wheels (11), adjust the feeding platform (6) to the level of the animal containment recipients (2) and proceed to feeding using dry or liquid food.

In the preferred embodiments of the present invention, an electric charging station of the battery or of the batteries of the robot (3) is installed in the proximities of the animal breeding installation.

In the preferred embodiments according to the invention, the locomotion platform (4) comprises at its base at least one skate for the linear track (29), configured to align with the horizontal, linear track (9).

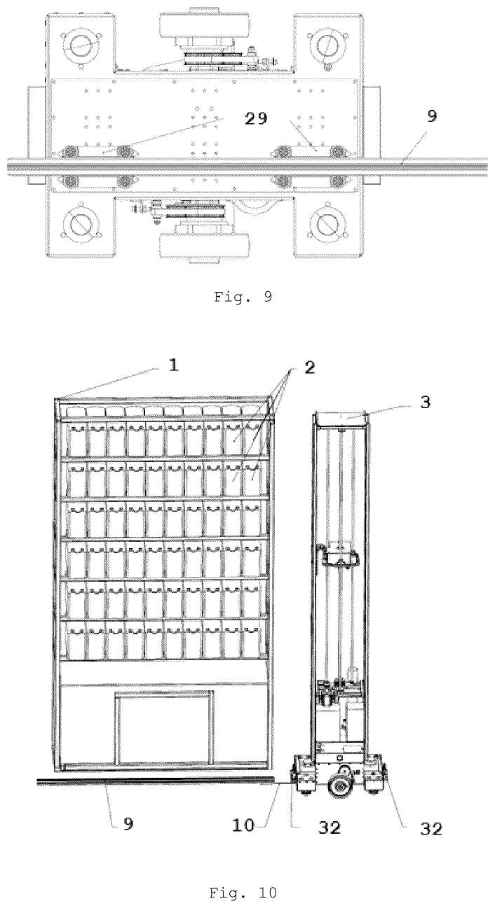

As illustrated in FIG. 9, preferably the locomotion platform has at its base two skates for the linear track (29), one of these components being disposed in a position upstream of the drive wheels (11) and the other component disposed downstream of said drive wheels (11). The skates for the linear track (29) help the locomotion platform (4) to adjust to the horizontal, linear track (9), which is installed on the ground and parallel to a certain rack (1) for animal containment recipients disposed in a row.

The robot (3) uses the sensorial navigation unit (13), namely the laser and odometry sensors to navigate outside of the horizontal, linear track (9) between two rows of racks or from or to the battery charger. As illustrated in FIG. 10, the robot (3) makes its approximation to the horizontal, linear track (9) by means of the optical sensors for following the reflective strip (32), in order to identify the reflective strip (10) and, consequently align itself with a certain rack for animal containment recipients disposed in a row (1). The alignment is performed automatically, bearing in mind the parallelism between the rack (1) and the horizontal, linear track (9).

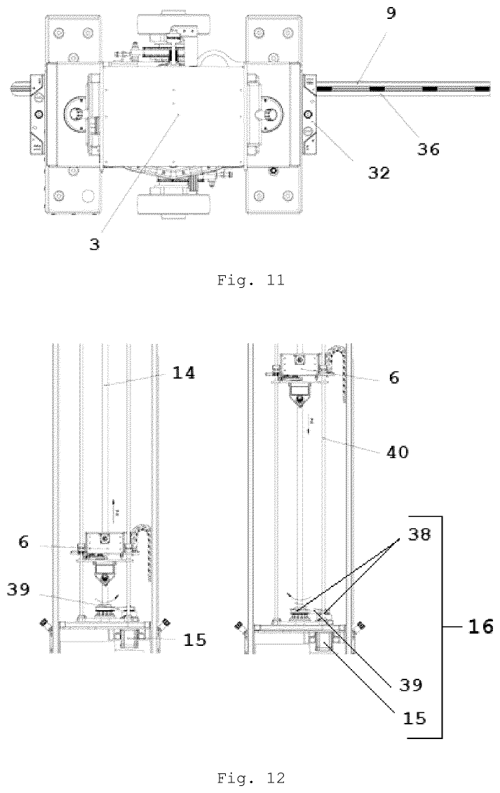

FIG. 11 illustrates the locomotion of the robot (3) along the horizontal, linear track (9), and after entry onto said track, the robot (3) can no longer make rotational movements, but only movements along said track, that is, along a Cartesian axis x, wherein the movements are forward and backward. In this embodiment, the horizontal, linear track (9) comprises a plurality of markers (36), which act as calibration marks, since they are detectable by the optical sensors for following the reflective strip (32), in order for any corrections of position of the locomotion platform (4) that need to be made.

### Hoisting Mechanism

A locomotion platform (4) is used to make the movement of the rack (17) on a horizontal plane, parallel to the ground, while the hoist mechanism (5) provides the movement of the feeding platform (6) along a Cartesian vertical z-axis, which is perpendicular to the ground.

In one of the embodiments of the present invention, the hoist mechanism (5) comprises at least one motor of the hoist mechanism (15), wherein the driving force is transferred to the feeding platform (6) by means of at least one pulley (38) and a transmission belt (39), wherein the hoist axis (14) is a spindle structure, configured to convert the angular rotation into linear movement.

The hoist mechanism (5) comprises a hoist axis (14), which is perpendicular to the horizontal, linear track (9); and a second motorization unit (16), which is configured to move the feeding platform (6) along the hoist axis (14); and the hoist mechanism (5) is connected to the locomotion platform (4). In the preferred embodiments, the second motorization unit (16) comprises a motor of the hoist mechanism (15), a pair of pulleys (38) and a transmission belt (39), wherein the pair of pulleys (38) enables the motor of the hoist mechanism (15) to be connected to the hoist axis (14).

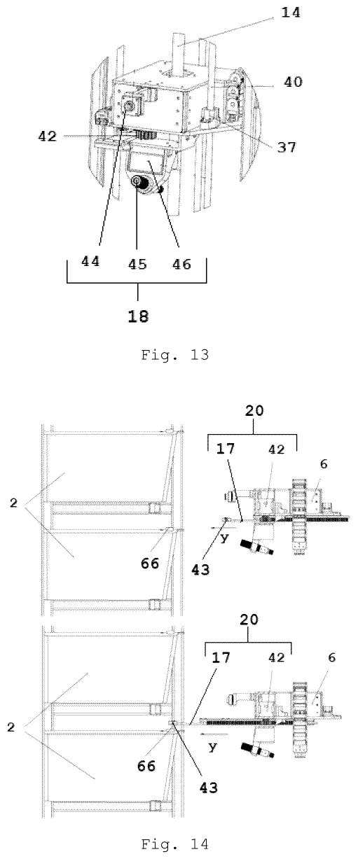

One embodiment of hoist mechanism (5) is shown in FIG. 12, wherein the hoist mechanism (5) is mounted on the top of the locomotion platform (4). The hoist mechanism (5) presents a hoist axis (14), namely a spindle axis, which converts angular movement into linear movement, when there is the actuation of a motor of the hoist mechanism (15). For this movement conversion to occur, the motor of the hoist mechanism (15) is connected to the hoist axis (14) by means of a pair of pulleys (38) and a transmission belt (39). In this illustrated embodiment, an anti-clockwise movement of the motor axis of the hoist mechanism (15) leads the feeding platform (6) to rise along the hoist axis (14), while a clockwise movement of the motor axis of the hoist mechanism (15) leads the feeding platform (6) to descend along the hoist axis (14). In this embodiment three stabilization rods of the hoist mechanism (40) are also used, which are also installed to align and stabilize the movement of the feeding platform (6).

The motor of the hoist mechanism (15) can be powered by a motor control board, which controls the speed and the position of the motor. The central processing unit (8) can be configured to communicate with the motor control board, in order to send the control instructions requested and receive information and data on the current phase and the position of the motor. Preferably, a calibration sensor of the hoist mechanism (41) can be used in the hoist mechanism (5), in order to perform the calibration of the real position of the feeding platform (6).

### Feeding Platform

The feeding platform (6) comprises the sensors needed to adjust the feed head (43) to the substance feeding zone in an animal containment recipient (2), for example an orifice disposed in a tank or aquarium with fish.

In the preferred embodiments of the invention, the third motorization unit (20) of the feeding platform (7) comprises a rack (17) and at least one motor (42) to move the rack (17) along a horizontal axis, which is perpendicular to the hoist axis (14), for the feed head (43) to reach the substance feeding zone in an animal containment recipient (2).

Preferably, the sensorial feeding unit (18) comprises a digital image capture sensor (44), configured to detect patterns in the rack (1) for animal containment recipients (2). Additionally, the sensorial feeding unit (18) comprises a distance measurement sensor (45), configured to measure the distance between the feed head (43) and the substance feeding zone in the animal containment recipient (2). Additionally, the sensorial feeding unit (18) comprises a bar code reading sensor (46), configured to read feeding parameters related to a certain animal containment recipient (2).

The feeding platform (6) comprises a sensorial feeding unit (18), a second processing unit (19), a third motorization unit (20), which includes a rack (17) and a motor (42) and a motor control board. As illustrated in FIG. 13, the sensorial feeding unit (18) includes a digital image capture sensor (44), namely a digital camera, a distance measurement sensor (45), and a bar code reading sensor (46), which has information and specific feeding parameters for a certain recipient (2). As a person skilled in the art will fully understand, any bar code label may be used in the ambit of the invention, namely a one-dimensional or two-dimensional bar code, for example a QR-code.

The second processing unit (19) may have ongoing communication with the central processing unit (8), in order to gather and transmit data from the sensorial feeding unit (18) to the central processing unit (8), and in order to receive from said unit (8) commands that are relayed to the feed head (43).

In the preferred embodiments of the invention, the digital image capture sensor (44), namely a digital camera, can be used to detect patterns in the animal containment recipients (2) and in the racks (1). The data distance capture sensor that enables an evaluation of the distance of the feed head (43) in relation to an animal containment recipient (2). The bar code reading sensor (46) can capture information related with the number of fish of a certain recipient (2), besides the food type and amount defined for a certain recipient (2).

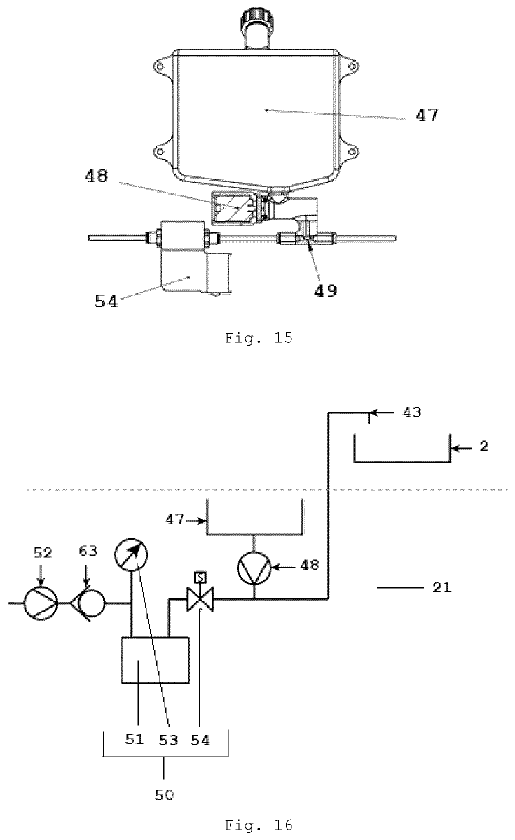

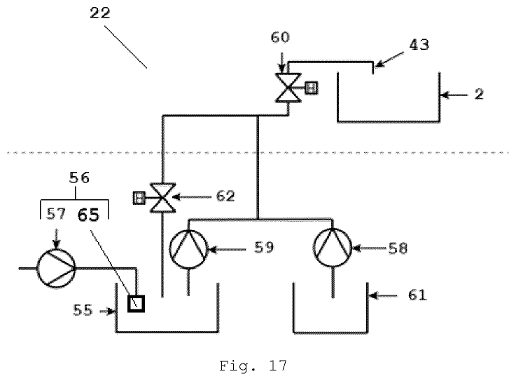

As illustrated in FIG. 14, the central processing unit (8) uses the data sent by the second processing unit (19) of the feeding platform (6) to compute the real position of a recipient (2), for example a tank, and adjust the position on the Cartesian x axis of the locomotion platform (4) along the horizontal, linear track (9) and also adjust the position of the feeding platform (6) on the Cartesian z axis. The second processing unit (19) of the feeding platform (6) transmits instructions for the motor of the feeding platform (42) to move the rack (17) forwards and backwards along the Cartesian y axis of the robot (3), such that a food entrance orifice (66) disposed in the recipient (2) is reached.

### Feeding Circuit

In the preferred embodiments according to the invention, the robot (3) is configured to feed animal containment recipients (2), namely tanks or aquariums with fish, disposed on a rack (1), wherein the recipients (2) are stacked on said rack (1), for example in a grid arrangement of rows and columns. The feeding circuit of the automated device for the controlled feeding of substances to animal containment recipients in an animal breeding installation is configured to supply foods and nutrients in liquid and/or solid form.

The dry feeding circuit (21) is configured to operate particularly with granulated substances, for example with feedstuffs for fish in granulated form. As a person skilled in the art will fully perceive, the type of substance to be fed and its physical form, for example the size of the particles, will depend on the type, size and specimens present in the recipient (2).

The liquid feeding circuit (22) is configured to operate particularly with substances that are solubilized or in suspension in a given liquid medium, for example a suspension of live organisms, namely incubated artemias and daphnias.

The dry feeding circuit (21) may present various capacities for housing dry food, and may include one or more reservoirs of dry feed substances (47) containing the same type of food, in cases where all the recipients (2) of the rack (1) are stored with the same type of food. Alternatively, the dry feeding circuit (21) may comprise reservoirs of dry feed substances (47) with different types of food. In the preferred embodiments of the invention, the reservoirs of dry feed substances (47) are installed on the locomotion platform (4). The reservoirs of dry feed substances (47) may be hand-supplied by means of an opening disposed on the top of each reservoir (47).

In the preferred embodiments according to the invention, the dry feeding circuit (21) of the feeding circuit (7) comprises a reservoir of dry food substances (47); a motor (48), configured to move a portion of dry food substance to a dry substance trigger chamber (49); and a compressed air circuit (50), configured to direct said portion of dry food substance from the dry substance trigger chamber (49) to the feed head (43).

FIG. 15 presents an embodiment of dry feeding circuit (21) with a reservoir of dry food substances (47), and at the bottom of each reservoir (47) a motor (48) is installed, configured to deliver the predetermined amount of food to a dry substance trigger chamber (49). The amount of food is a multiple of a previously defined value, and may vary depending on the amount, age and number of specimens, for example fish, present in the reservoir (2). This set of feeding parameters may be made available and considered by means of a bar code label, which is read by the bar code reading sensor (46). A food which is directed to the dry substance trigger chamber (49) is impelled to a tube of the feed head (43), by means of a compressed air circuit (50), being projected through the food entrance orifice (66) disposed in the recipient (2).

In the preferred embodiments of the invention, the compressed air circuit (50) comprises a compressed air tank (51); a pressure sensor (53), disposed upstream of said tank (51); and a pneumatic valve (54), configured to release the compressed air to the dry substance trigger chamber (49). Even more preferably, the compressed air tank (51) is pressurized by means of a compressed air compressor (52). The pressure sensor (53) is used to measure and regulate the pressure of the compressed air circuit (50). A non-return valve (63) may be used to prevent the compressed air from returning from the compressed air tank (51) to the compressed air compressor (52), when latter is switched off. Therefore, the compressed air tank (51) stores compressed air, which enables the feeding housed in the dry substance trigger chamber (49) to be propelled to the feed head (43), when the pneumatic valve (54) is activated, that is, opened.

The dry feeding circuit (21) is controlled by a controller of the feeding circuit (7), which manages the which manages the pressure in the compressed air circuit (50) and controls the quantity of food removed from each reservoir (47), besides activating or deactivating the pneumatic valve (54), in order to direct the desired quantity of food to the feed head (43).

In the preferred embodiments according to the invention, as illustrated in FIG. 17, the liquid feeding circuit (22) of the feeding circuit (7) comprises a reservoir of liquid food substances (55); a first liquid circulation pump (59) downstream of the reservoir of liquid food substances (55); a first hydraulic valve (60) downstream of the first liquid circulation pump (59) and upstream of the feed head (43); and a second hydraulic valve (62), parallel to the first hydraulic valve (60) and upstream of the reservoir of liquid food substances (55); and during the course of the liquid feeding to an animal containment recipient (2), the first hydraulic valve (60) is in an open position and the second hydraulic valve (62) is in a closed position, wherein the feed liquid pumped by the first liquid circulation pump (59) flows from the reservoir of liquid food substances (55) to the feed head (43).

Even more preferably, the liquid feeding circuit (22) of the feeding circuit (7) comprises a reservoir of cleaning liquid (61); a second liquid displacement pump (58) downstream of the reservoir of cleaning liquid (61) and upstream of the first hydraulic valve (60); and during the course of the cleaning of the liquid feeding circuit, the hydraulic valves (60, 62) are opened and closed alternately, such that the cleaning liquid pumped by the second liquid circulation pump (58) cleans the entire piping of the liquid feeding circuit (22).

Even more preferably, as illustrated in FIG. 17, the liquid feeding circuit (22) of the feeding circuit (7) comprises a homogenization system of the reservoir of liquid food substances (56), for example an air pump (57) and an air diffuser (65). The homogenization is relevant for cases where the liquid feeding is suspension of foods instead of a homogenous solution of foods, as is the case of dispersions with live organisms used as food sources. In these embodiments, the use of the air pump (57) is particularly preferred, as it helps maintain the vital conditions of said organisms.

As a person skilled in the art will understand, the device and the system according to the invention may be used to provide automated feeding to various types of animals housed in recipients (2), namely fish used as model organisms in scientific studies, for example the species Danio rerio. However, the present invention may be used in the breeding of other specimens used for experiment purposes, as per the non-limitative example: Danionella translucida, Devario aequipinnatus, Nothobranchius furzeri, Oryzias latipes and even Xenopus spp. Further, the present invention may also be used with the same functionalities in the breeding of other specimens, including those destined for breeding with food purposes, selection of specimens and aquariophilia in general.

As used during the course of this patent application, the term “or” is used in the inclusive sense instead of the exclusive sense, unless the exclusive sense is clearly defined in a specific situation. In this context, a phrase such as “X uses A or B” should be interpreted as including all the pertinent inclusive combinations, for example “X uses A”, “X uses B” and “X uses A and B”.

As used during the course of this patent application, the indefinite articles “a” or “an” should be interpreted generally as “one or more”, unless the sense of an embodiment singular is clearly defined in a specific situation.

As presented in this specification, the terms related with examples should be interpreted with the purpose of illustrating an example of something and not indicative as a preference.

As used in this specification, the expression “about” and “approximately” refers to a range of values of more or less 10% the specified number.

As used in this specification, the expression “substantially” means that the real value is within the range of about 10% of the related desired, variable or limit value, particularly within about 5% of the related desired, variable or limit value or especially within about 1% of the related desired, variable or limit value.

The subject matter-object described above is provided as an illustration of the present invention and should not be interpreted in a way that limits it. The terminology used with the purpose of describing specific embodiments, according to the present invention, should not be interpreted in a way that limits the invention. As used in the specification, the definite and indefinite articles, in their singular form, should be interpreted as inclusive of their plural forms as well, unless the context of the specification explicitly states otherwise. It shall be understood that the terms “comprise” and “include”, when used in this specification, specify the presence of the characteristics, of the elements, of the components, of the stages and of the related operations, but do not exclude the possibility that other characteristics, elements, components, stages and operations are also encompassed therein.

All the alterations, provided that they do not modify the essential characteristics of the accompanying claims, should be considered within the ambit of protection of the present invention.

### LIST OF REFERENCE INDICATIONS

1—A rack for animal containment recipients disposed in a row
2—An animal containment recipient
3—A robot
4—A locomotion platform
5—A hoist mechanism
6—A feeding platform
7—A feeding circuit
8—A central processing unit
9—A horizontal, linear track
10—A reflective strip
11—A drive wheel
12—A first motorization unit
13—A sensorial navigation unit
14—A hoist axis
15—A motor of the hoist mechanism
16—A second motorization unit
17—A rack
18—A sensorial feeding unit
19—A second processing unit
20—A third motorization unit
21—A dry feeding circuit
22—A liquid feeding circuit
23—A caster
24—A motor of the locomotion platform
25—A gearbox of the locomotion platform
26—A pulley of the locomotion platform
27—A transmission belt of the locomotion platform
28—A motor command unit
29—A skate for the linear track
30—A laser scanning sensor
31—An incremental rotary encoder sensor
32—An optical sensor for following a reflective strip
33—An inertial measurement unit (combination of accelerometer and gyroscope)
34—An energy management controller
35—A controller of the feeding circuit
36—A marker of the horizontal, linear track
37—A linear bearing
38—A pulley of the hoist mechanism
39—A transmission belt of the hoist mechanism
40—A stabilization rod of the hoist mechanism
41—A calibration sensor of the hoist mechanism
42—A motor of the feeding platform
43—A feed head
44—A digital image capture sensor
45—A distance measurement sensor
46—A bar code reading sensor
47—A reservoir of dry food substances
48—A motor of the dry feeding circuit
49—A dry substance trigger chamber
50—A compressed air circuit
51—A compressed air tank
52—A compressed air compressor
53—A pressure sensor
54—A pneumatic valve
55—A reservoir of liquid food substances
56—A homogenization system of the reservoir of liquid food substances
57—An air pump
58—A second liquid circulation pump
59—A first liquid circulation pump
60—A first hydraulic valve
61—A reservoir of cleaning liquid
62—A second hydraulic valve
63—A non-return valve
64—A step motor for dosing dry food
65—An air diffuser
66—A food entrance orifice

### LIST OF CITATIONS

The list of citations is as follows:

### LITERATURE ON PATENTS

U.S. Pat. No. 8,499,719B2, by Marco Brocca and Giovanni Frangelli and published on Aug. 6, 2013;
CN105684979A, by Zhang Qiong and published on Jun. 22, 2016;
WO2009072982A1, by Lau Lionel et al. and published on Jun. 11, 2009.

1. An automated device for the controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, characterized by comprising:
a robot (3), comprising a locomotion platform (4); a hoist mechanism (5); a feeding platform (6); a feeding circuit (7); and a central processing unit (8);
wherein the robot (3) is configured to transit on at least one horizontal, linear track (9), which is disposed parallel to each rack for animal containment recipients disposed in a row (1), wherein a reflective strip (10) is disposed next to a terminal position of said horizontal, linear track (9);
wherein the locomotion platform (4) comprises at least one drive wheel (11); a first motorization unit (12) and a sensorial navigation unit (13); the sensorial navigation unit (13) being configured to locate and navigate the platform in the work space and to detect the reflective strip (10) and the first motorization unit (12) configured to move the locomotion platform (4) along the horizontal, linear track (9);
wherein the hoist mechanism (5) comprises a hoist axis (14), which is perpendicular to the horizontal, linear track (9); and a second motorization unit (16), which is configured to move the feeding platform (6) along the hoist axis (14); and
the hoist mechanism (5) is connected to the locomotion platform (4)
wherein the feeding platform (6) comprises a rack (17), which is connected to a feed head (43); a sensorial feeding unit (18), which is configured to send data to the central processing unit (8) on the position of the feed head (43) in relation to the feeding zone of the animal containment recipient (2); a second processing unit (19); a third motorization unit (20), which is configured to move the rack (17) along a horizontal axis, which is perpendicular to the hoist axis (14), for the feed head (43) to reach the substance feeding zone in an animal containment recipient (2);
wherein the feeding circuit (7) comprises one or more feeding circuits selected from the group consisting of a dry feeding circuit (21) and a circuit of liquid feeding circuit (22);
wherein the central processing unit (8) receives data on position, orientation and speed relating to the locomotion platform (4), said data being collected by the sensorial navigation unit (13) and processed by the central processing unit (8);
wherein the central processing unit (8) receives data on feeding parameters for each animal containment recipient (2), said data being collected by the sensorial feeding unit (18) and processed by the second processing unit (19);
wherein the central processing unit (8) controls the movement of the locomotion platform (4) along at least one horizontal, linear track (9) and along at least one passage adjacent to a horizontal, linear track (9), the movement of the feeding platform (6) along the hoist axis (14) and the feeding of the animal containment recipients (2) by the feed head (43).

2. The automated device for the controlled feeding of substances to animal containment recipients in an animal breeding installation, according to the preceding claim, characterized in that the locomotion platform (4) comprises at least two drive wheels (11) and at least four casters (23), two casters (23) being disposed in a front position in relation to said drive wheels (11) and two casters (23) disposed in a rear position in relation to said drive wheels (11).

3. The automated device for the controlled feeding of substances to animal containment recipients in an animal breeding installation, according to the preceding claim, characterized in that the locomotion platform (4) comprises at its base at least one skate for the linear track (29), configured to align with the horizontal, linear track (9).

4. The automated device for the controlled feeding of substances to animal containment recipients in an animal breeding installation, according to any one of the preceding claims, characterized in that the first motorization unit (12) comprises at least two motors (24) and a gearbox (25), wherein the power is transferred to the drive wheels (11) by means of at least two pulleys (26) and a transmission belt (27).

5. The automated device for the controlled feeding of substances to animal containment recipients in an animal breeding installation, according to any one of the preceding claims, characterized in that the sensorial navigation unit (13) comprises one or more sensors selected from the group consisting of a laser scanning sensor (30), an incremental rotary encoder sensor (31), an optical sensor for following a reflective strip (32) and an inertial measurement unit (33), configured to collect data related to the position, to the orientation and to the speed of the locomotion platform (4).

6. The automated device for the controlled feeding of substances to animal containment recipients in an animal breeding installation, according to any one of the preceding claims, characterized in that the horizontal, linear track (9) comprises a plurality of markers (36), disposed along the length of said linear track, which are selected from the group comprised of markers detectable by optical sensors or by magnetic sensors.

7. The automated device for the controlled feeding of substances to animal containment recipients in an animal breeding installation, according to any one of the preceding claims, characterized in that the hoist mechanism (5) comprises at least one motor of the hoist mechanism (15), wherein the driving force is transferred to the feeding platform (6) by means of at least one pulley (38) and a transmission belt (39), wherein the hoist axis (14) is a spindle structure, configured to convert the angular rotation into linear movement.

8. The automated device for the controlled feeding of substances to animal containment recipients in an animal breeding installation, according to any one of the preceding claims, characterized in that the third motorization unit (20) of the feeding platform (7) comprises at least one motor (42) to move the rack (17) along a horizontal axis, which is perpendicular to the hoist axis (14), for the feed head (43) to reach the substance feeding zone in an animal containment recipient (2).

9. The automated device for the controlled feeding of substances to animal containment recipients in an animal breeding installation, according to any one of the preceding claims, characterized in that the sensorial feeding unit (18) comprises a digital image capture sensor (44), configured to detect patterns in the rack (1) for animal containment recipients (2).

10. The automated device for the controlled feeding of substances to animal containment recipients in an animal breeding installation, according to any one of the preceding claims, characterized in that the sensorial feeding unit (18) comprises a distance measurement sensor (45), configured to measure the distance between the feed head (43) and the substance feeding zone in an animal containment recipient (2).

11. The automated device for the controlled feeding of substances to animal containment recipients in an animal breeding installation, according to any one of the preceding claims, characterized in that the sensorial feeding unit (18) comprises a bar code reading sensor (46), configured to read feeding parameters related to a certain animal containment recipient (2).

12. The automated device for the controlled feeding of substances to animal containment recipients in an animal breeding installation, according to any one of the preceding claims, characterized in that the dry feeding circuit (21) of the feeding circuit (7) comprises a reservoir of dry food substances (47); a motor (48), configured to move a portion of dry food substance to a dry substance trigger chamber (49); and a compressed air circuit (50), configured to propel said portion of dry food substance from the dry substance trigger chamber (49) to the feed head (43).

13. The automated device for the controlled feeding of substances to animal containment recipients in an animal breeding installation, according to the preceding claim, characterized in that the compressed air circuit (50) comprises a compressed air tank (51); a pressure sensor (53), disposed upstream of said tank (51); and a pneumatic valve (54), configured to release the compressed air to the dry substance trigger chamber (49).

14. The automated device for the controlled feeding of substances to animal containment recipients in an animal breeding installation, according to the preceding claim, characterized in that the compressed air tank (51) is pressurized by means of a compressed air compressor (52).

15. The automated device for the controlled feeding of substances to animal containment recipients in an animal breeding installation, according to any one of the preceding claims, characterized in that the liquid feeding circuit (22) of the feeding circuit (7) comprises a reservoir of liquid food substances (55); a first liquid circulation pump (59) downstream of the reservoir of liquid food substances (55); a first hydraulic valve (60) downstream of the first liquid circulation pump (59) and upstream of the feed head (43); and a second hydraulic valve (62), parallel to the first hydraulic valve (60) and upstream of the reservoir of liquid food substances (55); and during the course of liquid feeding to an animal containment recipient (2), the first hydraulic valve (60) is in an open position and the second hydraulic valve (62) is in a closed position, wherein the feed liquid pumped by the first liquid circulation pump (59) flows from the reservoir of liquid food substances (55) to the feed head (43).

16. The automated device for the controlled feeding of substances to animal containment recipients in an animal breeding installation, according to the preceding claim, characterized in that the liquid feeding circuit (22) of the feeding circuit (7) comprises a reservoir of cleaning liquid (61); a second liquid displacement pump (58) downstream of the reservoir of cleaning liquid (61) and upstream of the first hydraulic valve (60); and during the course of the cleaning of the liquid feeding circuit, the hydraulic valves (60, 62) are opened and closed alternately, such that the cleaning liquid pumped by the second liquid circulation pump (58) cleans the entire piping of the liquid feeding circuit (22).

17. The automated device for the controlled feeding of substances to animal containment recipients in an animal breeding installation, according to any one of the claims 15 and 16, characterized in that the liquid feeding circuit (22) of the feeding circuit (7) comprises a homogenization system of the reservoir of liquid food substances (56).

18. An automated system for the controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, characterized by comprising:
an automated device for the controlled feeding of substances to animal containment recipients in an animal breeding installation, as defined in any one of the preceding claims; and
at least one horizontal, linear track (9), which is disposed on the ground and parallel to each rack for animal containment recipients disposed in a row (1), wherein a reflective strip (10) is disposed next to a terminal position of said horizontal, linear track (9).

19. A method of controlled feeding of substances to animal containment recipients in an animal breeding installation, which includes at least one rack for animal containment recipients disposed in a row (1) comprising a plurality of animal containment recipients (2), wherein said recipients are disposed in the form of a grid on said rack, characterized by comprising the following steps:
i. an automated device, as defined in any one of claims 1 to 17, transiting alongside at least one rack for animal containment recipients disposed in a row (1);
ii. said automated device detecting a horizontal, linear track (9), which is disposed on the ground and parallel to each rack for animal containment recipients disposed in a row (1);
iii. said automated device moving along the horizontal, linear track (9) by means of a locomotion platform (4), comprised in said automated device, in order to position itself opposite an axis perpendicular to the ground, which passes by a certain animal containment recipient (2);
iv. a hoist mechanism (5) of said automated device adjusting the position of a feeding platform (6) along said axis perpendicular to the ground, which passes by a certain animal containment recipient (2), in order to position the feeding platform (6) at the height of a certain animal containment recipient (2);
v. The feeding platform (6) adjusting the position of a rack (17) along a plane parallel to the ground, in order for a feed head (43) to reach a substance feeding zone in a certain animal containment recipient (2);
vi. The automated device repeating the preceding steps until the food is supplied to a predetermined set of animal containment recipients (2) disposed on the rack (1).

20. The method of controlled feeding of substances to animal containment recipients in an animal breeding installation, according to the preceding claim, characterized in that the animal containment recipient (2) is a tank for housing fish.

21. The method of controlled feeding of substances to animal containment recipients in an animal breeding installation, according to the preceding claim, characterized in that the fish are selected from one or more of the group consisting of Danio rerio, Danionella translucida, Devario aequipinnatus, Nothobranchius furzeri, Oryzias latipes and Xenopus spp.
